(19) United States
(12) Patent Application Publication
(10) Pub. No.: US 2017/0210329 A1
(43) Pub. Date: Jul. 27, 2017

(54) DOOR-MOUNTED AIRBAG ASSEMBLY

(71) Applicant: Ford Global Technologies, LLC, Dearborn, MI (US)

(72) Inventors: Manoharprasad K. Rao, Novi, MI (US); Mark A. Cuddihy, New Boston, MI (US); Saeed David Barbat, Novi, MI (US)

(73) Assignee: Ford Global Technologies, LLC, Dearborn, MI (US)

(21) Appl. No.: 15/005,089

(22) Filed: Jan. 25, 2016

(51) Int. Cl. B60R 21/21; B60R 21/261; B60R 21/231; B60N 2/46; B60R 21/233; B60R 21/0136

(52) U.S. Cl. CPC B60R 21/21; B60R 21/233; B60R 21/0136; B60R 21/23138; B60N 2/46; B60R 21/261; B60R 2021/23153

(57) ABSTRACT

A door assembly for a vehicle includes a door, an inflator mounted to the door, and a passive restraint. The passive restraint has a first airbag chamber and a second airbag chamber. The first airbag chamber is in communication with the inflator and is inflatable from an uninflated position to an inflated position. The second airbag chamber is in communication with the inflator and is inflatable from an uninflated position to an inflated position. The first airbag chamber in the inflated position extends transverse to the second airbag chamber in the inflated position.

### BACKGROUND

Airbags can provide protection for front and rear passengers of a vehicle. A vehicle may be equipped with sensors that can detect when the vehicle is in a collision. A controller or controllers may be in communication with the sensors and with the airbags. Depending on the signals from the sensors—which can indicate, for example, the direction of the collision—the controller may instruct the airbags or a subset of the airbags to deploy. The deployed airbags help cushion and protect the passengers from the forces of the collision.

One class of vehicles on which airbags can be installed is autonomous vehicles. Autonomous vehicles are capable of navigating themselves without the intervention of a driver. Because of the reduced importance of the driver, autonomous vehicles may have different interior layouts than non-autonomous vehicles.

### BRIEF DESCRIPTION OF THE DRAWINGS

FIG. 1 is an overhead view of a vehicle interior.

FIG. 2 is an exploded view of a vehicle door.

FIG. 3 is an overhead view of a vehicle interior with two airbag chambers inflated from the vehicle door.

FIG. 4 is a side view of a vehicle interior with two airbag chambers inflated from the vehicle door.

FIG. 5 is an overhead view of an airbag assembly with the airbag chambers inflated.

FIG. 6 is an overhead view of an airbag assembly with the airbag chambers inflated.

FIG. 7 is a block diagram of an airbag assembly.

FIG. 8 is a schematic view of an impact detection system.

### DETAILED DESCRIPTION

With reference to the Figures, wherein like numerals indicate like parts throughout the several views, a door assembly for a vehicle 30 includes a door 38, an inflator 46 mounted to the door 38, and a passive restraint 28. The passive restraint 28 has a first airbag chamber 42 and a second airbag chamber 44. The first airbag chamber 42 is in communication with the inflator 46 and is inflatable from an uninflated position to an inflated position. The second airbag chamber 44 is in communication with the inflator 46 and is inflatable from an uninflated position to an inflated position. The first airbag chamber 42 in the inflated position extends transverse to the second airbag chamber 44 in the inflated position.

The transverse airbag chambers 42 and 44 of the passive restraint 28 help increase protection for a passenger in both front and side collisions. The door mounting helps increase protection for a rear seat passenger regardless of the position or orientation of a front seat, or the position and orientation of the front seat may be taken into account. By contrast, an airbag mounted in the seatback of the front seat may require constant recalibration depending on adjustments in the seat position by the front-seat passenger. Furthermore, in an autonomous vehicle, for example, the front seat may be rotated to face rearward, rendering an airbag mounted in the seatback of the front seat ineffective. Moreover, the single inflator 46 reduces complexity by serving two airbag chambers that can be useful in different crash scenarios.

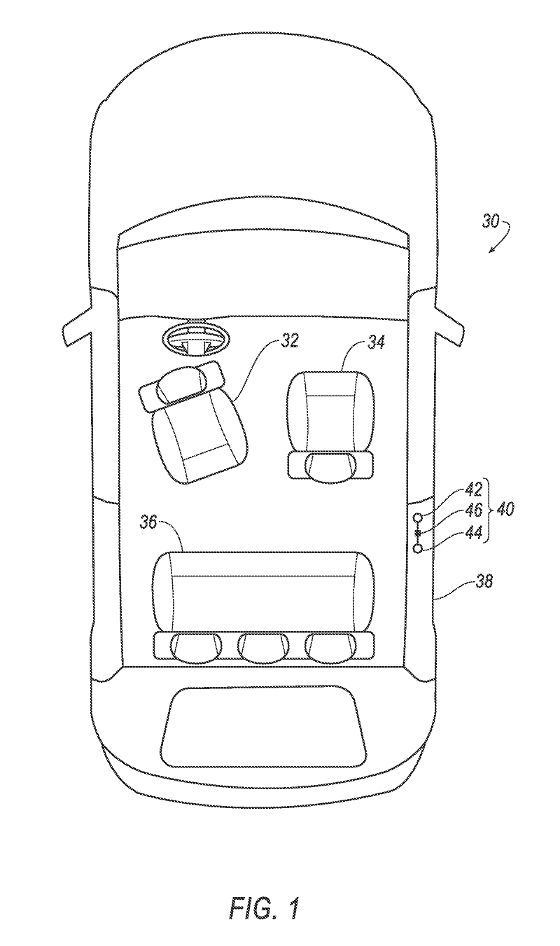

As shown in FIG. 1, the vehicle 30 includes front seats 32 and 34 and a rear seat 36. A rear door 38 is adjacent the rear seat 36. The rear door 38 houses at least one airbag assembly 40, each of which includes one or more chambers such as the first airbag chamber 42 and the second airbag chamber 44, both shown in an uninflated position, and at least one inflator 46 in communication with the airbag chambers 42 and 44. The first and second airbag chambers 42 and 44 serve as the passive restraint 28. The first airbag chamber 42 is inflatable between the front seat 34 and the rear seat 36, and the second airbag chamber 44 is inflatable along the rear door 38. The vehicle 30 also contains an impact sensing system 48 (see FIG. 9).

Although FIG. 1 depicts the front seats 32 and 34 as bucket seats and the rear seat 36 as a bench seat, other configurations are possible. For example, the front seats 32 and 34 may instead be split bench seats or a single bench seat, and the rear seat 36 may instead be split or be two bucket seats. Furthermore, particularly in autonomous vehicles, the front seats 32 and 34 may be rotatable to face a different direction in the cabin than only forward. The front seats 32 and 34 are rotatable up to 360° between a front-facing position and a rear-facing position. In FIG. 1, the front seat 32 is in a rear-facing position.

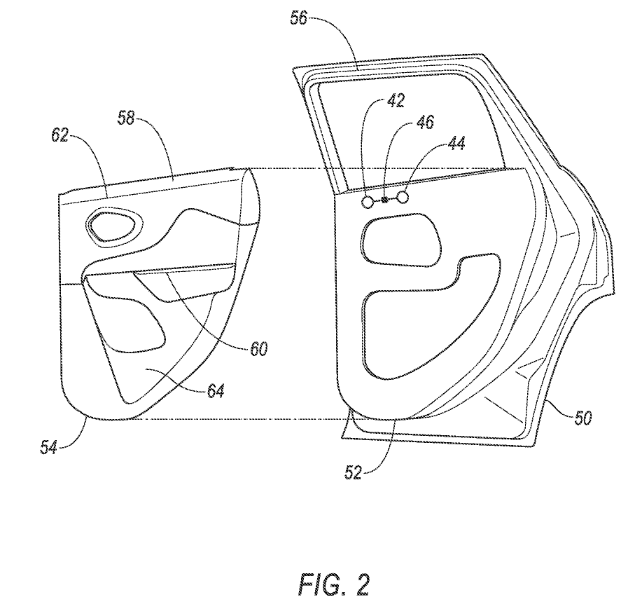

The rear door 38 is shown in greater detail in FIG. 2. The door 38 includes an outer panel 50, an inner frame 52, a trim panel 54, a window opening 56, and a bezel 58. The trim panel 54 includes an armrest 60 and is shown exploded away from the rest of the door 38 to reveal the interior of the door 38 and the airbag assembly 40. An inflator 46 is mounted to the inner frame 52, although in different implementations the inflator 46 may be mounted to other components of the door 38. The first and second airbag chambers 42 and 44 are in communication with the inflator 46. The airbag chambers 42 and 44, shown in an uninflated position, are inflatable from the uninflated position to an inflated position; in the uninflated position, the airbag chambers 42 and 44 are covered by the trim panel 54 and disposed within the bezel 58, and in the inflated position, they extend from the trim panel 54, for example, through a seam 62 in the trim panel 54. Other implementations may use different configurations of the seam 62 incorporated in the trim panel 54 to facilitate easy deployment of the airbag chambers 42 and 44. This placement of the airbag chambers 42 and 44 locates them above the armrest 60.

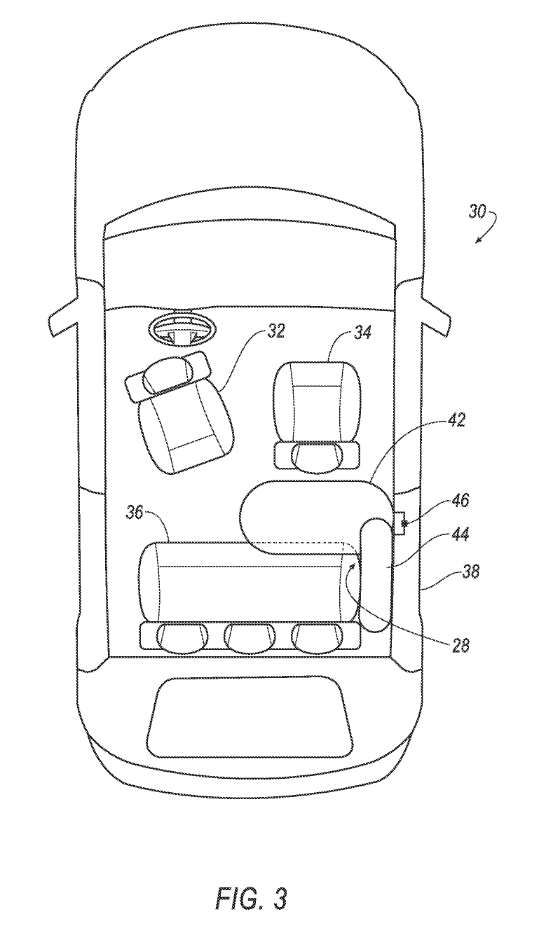

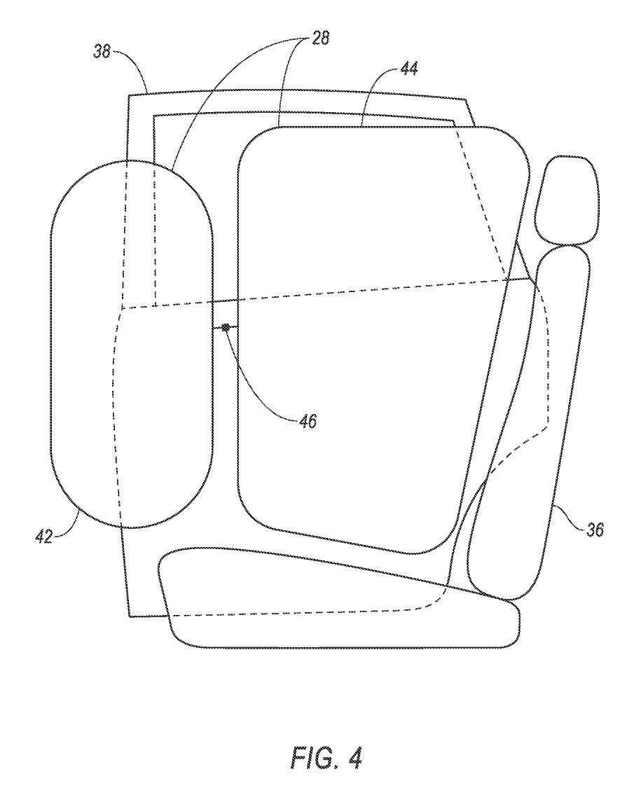

As set forth above, the first airbag chamber 42 and the second airbag chamber 44 of the passive restraint 28 extend transverse to each other in the inflated position. For example, as shown in FIG. 3, the first airbag chamber 42 in the inflated position may extend substantially perpendicular to the second airbag chamber 44 in the inflated position. The first airbag chamber 42 inflates in a direction perpendicular to the door 38, which places the chamber 42 between a passenger seated in the rear seat 36 and the back of the front seat 34 or, if the front seat 34 is oriented toward the rear of the vehicle 30, between a passenger seated in the rear seat 36 and a passenger seated in the front seat 34. The second airbag chamber 44 in the inflated position extends parallel to the door 38, which places the chamber 44 between a passenger seated in the rear seat 36 and the rear door 38. As seen in FIG. 4, the second airbag chamber 44 may extend above and below its uninflated position on the vehicle door 38.

The inflator 46, the first airbag chamber 42, and the second airbag chamber 44 are components of the airbag assembly 40. The first airbag chamber 42 and the second airbag chamber 44 are in communication with the inflator 46 to expand the first and second airbag chambers with an inflation medium, such as a gas. The inflator 46 may be, for example, a pyrotechnic inflator 46 that uses a chemical reaction to drive inflation medium to the chambers 42 and 44. The inflator 46 may be of any suitable type, for example, a cold-gas inflator. The airbag assembly may include other components, for example, a case, electronics, etc.

The airbag chambers 42 and 44 may be formed of any suitable material, for example, a woven polymer. For example, the airbag chambers 42 and 44 may be formed of woven nylon yarn, for example, nylon 6-6. Other suitable examples include polyether ether ketone (PEEK), polyetherketoneketone (PEKK), polyester, or any other suitable polymer. The woven polymer may include a coating, such as silicone, neoprene, urethane, and so on. For example, the coating may be polyorgano siloxane.

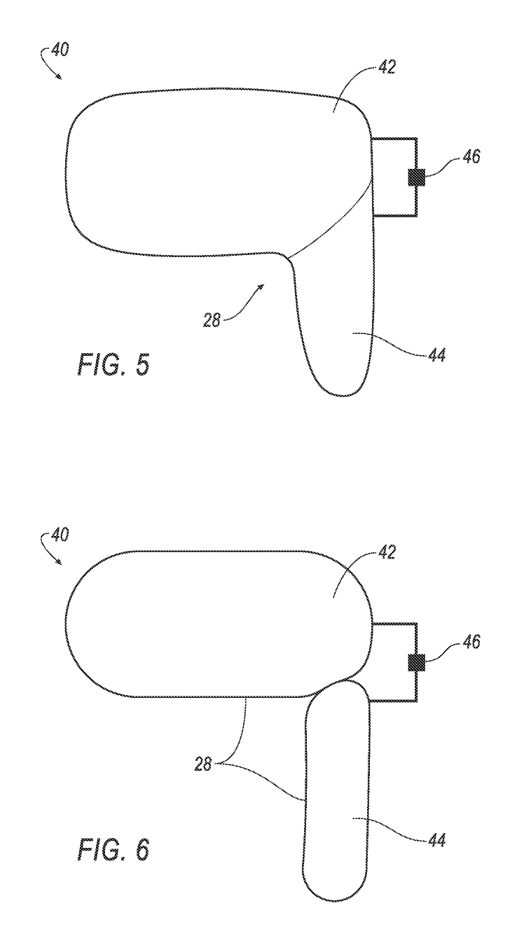

In one possible approach, shown in FIG. 5, the first airbag chamber 42 and the second airbag chamber 44 of the passive restraint 28 are in direct fluid communication with each other. The two chambers 42 and 44 constitute a single, L-shaped airbag. In a different possible implementation, shown in FIG. 6, the first airbag chamber 42 and the second airbag chamber 44 are separately connected to the inflator 46 and are fluidly disconnected from each other. Each of the two chambers 42 and 44 is its own airbag. In each of these approaches, the first airbag chamber 42 and the second airbag chamber 44 are independently inflatable from the uninflated position to the inflated position.

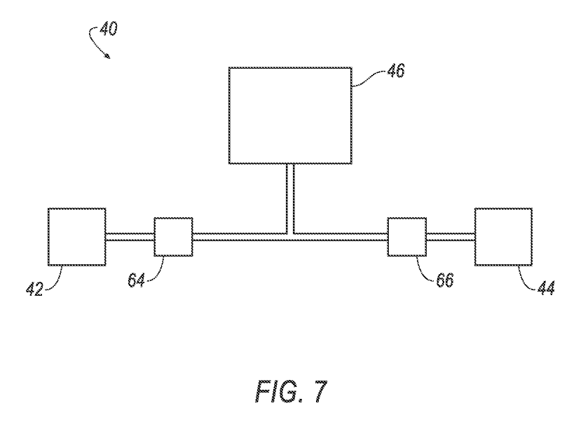

Independent inflation via a single inflator 46 may be achieved by the airbag assembly 40 including a first valve 64 between the inflator 46 and the first airbag chamber 42 and moveable between closed and open positions, and a second valve 66 between the inflator 46 and the second airbag chamber 44 and moveable between closed and open positions, as shown in FIG. 7. In operation, if the first valve 64 is open and the second valve 66 is closed, then the inflator 46 will communicate inflatable medium to the first airbag chamber 42. If the first valve 64 is closed and the second valve 66 is open, then the situation reverses: the second airbag chamber 44 will change to an inflated position, but the first airbag chamber 42 will not. If both valves 64 and 66 are open, then both chambers 42 and 44 will inflate.

Alternatively, independent inflation via a single inflator 46 may be achieved by using a single dual-chambered inflator having two chambers with a pyrotechnic charge in each chamber being independently activated by signals received from the impact sensing system 48.

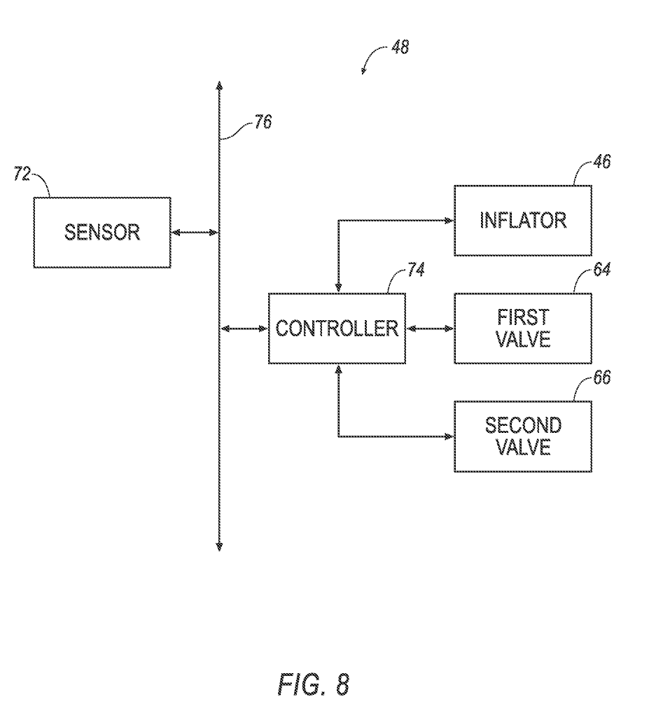

A schematic of the impact sensing system 48 is shown in FIG. 8. The impact sensing system 48 may include at least one sensor 72 for sensing impact of the vehicle 30, and a controller 74 in communication with the sensor 72 and the inflator 46 for activating the inflator 46, for example, for providing an impulse to a pyrotechnic charge of the inflator 46, when the sensor 72 senses an impact of the vehicle 30. Moreover, the controller 74 may be in communication with the valves 64 and 66 for opening one or both of the valves or may be in communication with an inflator 46 that is dual-chambered for discharging one or both chambers. Alternatively or additionally to sensing an impact, the impact sensing system 48 may predict a potential impact, that is, pre-impact sensing. The sensor 72 may be of any suitable type, for example, post-contact sensors such as accelerometers, pressure sensors, and contact switches; and pre-impact sensors such as radar, lidar, or vision-sensing systems. The vision systems may include one or more cameras, CCD image sensors, CMOS image sensors, etc. The sensor 72 may be included within the rear door 38, and, additionally, multiple sensors may also be located elsewhere in the vehicle.

The controller 74 may be a microprocessor-based controller. The sensor 72 is in communication with the controller 74 to communicate data to the controller 74. The controller 74 is programmed to output command signals to independently change the first and second airbag chambers 42 and 44 from the uninflated positions to the inflated positions based on a detected direction of vehicle impact, determined by the sensor 72. More specifically, the controller 74 is programmed to output control signals to independently move the first valve 64 and the second valve 66 from the closed position to the open position, or the controller 74 is programmed to output control signals to independently activate the pyrotechnic charges of one or both chambers of an inflator 46 that is dual-chambered.

The controller 74 and the sensor 72 may be connected to a communication bus 76, such as a controller area network (CAN) bus, of the vehicle 30. The controller 74 may use information from the communication bus 76 to control the inflator 46. The inflator 46 may be connected to the controller 74, as shown in FIG. 9, or may be connected directly to the communication bus 76. The same goes for the valves 64 and 66, shown in FIG. 8, or the dual-chambered inflator 46, not pictured in FIG. 8.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. (canceled)

2. The vehicle door assembly according to claim 12, wherein the door includes a trim panel, and the first and second airbag chambers, in their respective uninflated positions, are covered by the trim panel and extend from the trim panel in their respective inflated positions.

3. The vehicle door assembly according to claim 12, wherein the first airbag chamber in the inflated position extends substantially perpendicular to the second airbag chamber in the inflated position.

4. The vehicle door assembly according to claim 12, wherein the door includes a window opening and a bezel adjacent the window opening, the first and second airbag chambers being disposed in the bezel in the uninflated positions.

5. The vehicle door assembly according to claim 12, wherein the door includes an armrest, and the first and second airbag chambers are disposed above the armrest.

6. (canceled)

7. (canceled)

8. (canceled)

9. (canceled)

10. (canceled)

11. The vehicle door assembly according to claim 12, wherein the door is a rear door.

12. A vehicle door assembly comprising:
a door;
an inflator mounted to the door;
a passive restraint having a first airbag chamber and a second airbag chamber, wherein the first airbag chamber is in communication with the inflator and inflatable from an uninflated position to an inflated position and wherein the second airbag chamber is in communication with the inflator and inflatable from an uninflated position to an inflated position; and
a controller programmed to change one of the first and second airbag chambers from its uninflated position to its inflated position based on a detected direction of vehicle impact without changing the other of the first and second airbag chambers from its uninflated position to its inflated position.

13. The vehicle door assembly according to claim 12, wherein the first airbag chamber and the second airbag chamber are in direct fluid communication with each other.

14. The vehicle door assembly according to claim 12, wherein the first airbag chamber and the second airbag chamber are separately connected to the inflator and are fluidly disconnected from each other.

15. The vehicle door assembly according to claim 12, wherein the first airbag chamber in the inflated position extends transverse to the second airbag chamber in the inflated position.

16. The vehicle door assembly according to claim 12, further comprising:
a first valve between the inflator and the first airbag chamber and moveable between closed and open positions;
a second valve between the inflator and the second airbag chamber and moveable between closed and open positions; and
the controller is programmed to independently move the first valve and the second valve from the closed position to the open position.

17. The vehicle door assembly according to claim 12, wherein the inflator is further defined as a dual-chambered inflator having two chambers and the controller is programmed to independently activate the chambers.

18. The vehicle door assembly according to claim 12, further comprising an impact sensor in communication with the controller.

19. (canceled)

20. The vehicle door assembly of claim 12, further comprising a front seat rotatable between a front-facing and a rear-facing position, and a rear seat.

21. The vehicle door assembly of claim 20, wherein the door is a rear door adjacent the rear seat.

22. The vehicle door assembly of claim 21, wherein the inflated position of the first airbag chamber is between the front seat and rear seat, and the inflated position of the second airbag chamber is along the door.
